(19) United States
(12) Patent Application Publication
(10) Pub. No.: US 2012/0247869 A1
(43) Pub. Date: Oct. 4, 2012

(54) LADDER SAFETY APPARATUS

(76) Inventor: Patrick K. ANDERSON, Prairieville, LA (US)

(21) Appl. No.: 12/814,052

(22) Filed: Jun. 11, 2010

Related U.S. Application Data
(63) Continuation-in-part of application No. 11/675,897, filed on Feb. 16, 2007, now abandoned.
(60) Provisional application No. 61/186,297, filed on Jun. 11, 2009.
(60) Provisional application No. 60/774,294, filed on Feb. 16, 2006.

(51) Int. Cl. E06C 7/18

(52) U.S. Cl. 182/8

(57) ABSTRACT

A safety ladder that protects a climber from a fall is disclosed. The device provides a ladder having a plurality of rails and rungs, one of the rails being an elongated channel having multiple flanges surrounding a passageway, a pair of the flanges defining there between a gap. A locking member is configured to travel upwardly in the passageway, the locking member having a beam, a cam section at one end portion of the beam and an eyelet that is positioned outside of the passageway. A cable connects a climber to the connector section. The cam section is specially configured and forms an anchor with the channel in a locking position when a climber pulls down on the cable and locking member. The rail or rails flanges form an acute angle with the rungs.

### CROSS-REFERENCE TO RELATED APPLICATIONS

U.S. Provisional Patent Application Ser. No. 61/186,297, filed 11 Jun. 2009, is incorporated herein by reference. Priority of that application is hereby claimed.

This is a continuation-in-part of U.S. patent application Ser. No. 11/675,897, filed 16 Feb. 2007, and incorporated herein by reference. PCT Application No. PCT/US2007/062326, filed 16 Feb. 2007, is incorporated herein by reference. U.S. Provisional Patent Application Ser. No. 60/774,294, filed 16 Feb. 2006, is incorporated herein by reference. Priority of that application is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to safety devices for preventing inadvertent injury to a ladder climber by connecting the climber to the ladder with a harness arrangement that provides a locking member that slides in a vertically extended channel attached to the ladder during ascent and that forms an anchor in the event of a fall. More particularly, the present invention relates to an improved ladder safety apparatus that provides an elongated channel that extends upwardly along the ladder, the channel providing a passageway for holding a cam locking member, wherein the cam locking member can be pulled upwardly with little or no resistance but locks to provide an anchor when pulled downwardly such as when the climber falls.

2. General Background of the Invention

Workers are often required to climb to dangerous elevations such as when scaffolding is in use. It is known to bolt or otherwise rigidly attach an elongated vertically extended ladder to scaffolding so that workers can ascend dozens of feet (many meters) in the air in order to reach a selected level of a scaffolding. During this ascent, the climber is subjected to potential injury or death if he or she loses a firm grip on the ladder.

Several patents have issued that relate generally to safety devices that help a climber when ascending a ladder.

The following US Patents are examples of such devices, each being incorporated herein by reference:

TABLE

| PAT. | | ISSUE DATE |
|---|---|---|
| NO. | TITLE | (MM-DD-YYYY) |
| 2,616,609 | Tower Ladder Safety Device | 11-04-1952 |
| 3,348,632 | Climbing Device | 10-24-1967 |
| 3,523,591 | Climbing Safety Device | 08-11-1970 |
| 3,885,647 | Climbing Safety Device | 05-27-1975 |
| 4,085,818 | Plastic Ladder and Safety Device | 04-25-1978 |
| 4,111,280 | Supporting Guide Rail for Ladder | 09-05-1978 |
| | Safety Device | |
| 4,130,177 | Ladder Climber's Safety Device | 12-19-1978 |
| 4,193,475 | Rigid Rail Safety Device | 03-18-1980 |
| 4,269,284 | Sliding Clamp and Adaptor | 05-26-1981 |
| 5,238,084 | Safety Device for Climbing Ladders | 08-24-1993 |
| 6,161,647 | Fall Arresting Ladder Safety Device | 12-19-2000 |
| 6,837,337 | Fall Arrest Safety Device | 01-04-2005 |

### BRIEF SUMMARY OF THE INVENTION

The present invention provides an improved ladder safety apparatus that features an elongated flanged channel that is attached to and that extends along a ladder to be climbed. A specially configured cam locking member travels in the channel and can be pulled upwardly with little or no resistance as the climber ascends the ladder. In one embodiment, the channel forms a rail of the ladder. In one embodiment, the channel is positioned in between a pair of ladder rails.

If the climber loses his or her grip on the ladder and falls, the cam locking member immediately grips the channel, preventing downward movement of the cam locking member. A lanyard, rope, or cable can be used to attach the user to the cam locking member by fastening to a belt, vest or harness worn by the user.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a fragmentary side view of the preferred embodiment of the apparatus of the present invention;

FIG. 2 is a top view taken along lines 2-2 of FIG. 1;

FIG. 3 is a partial perspective view of the preferred embodiment of the apparatus of the present invention;

FIG. 4 is a partial perspective view of an alternative embodiment of the apparatus of the present invention;

FIG. 5 is a partial perspective view of the preferred embodiment of the apparatus of the present invention;

FIG. 6 is a fragmentary side view of the preferred embodiment of the apparatus of the present invention;

FIG. 7 is a fragmentary side view of the preferred embodiment of the apparatus of the present invention;

FIG. 8 is a perspective view of the preferred embodiment of the apparatus of the present invention;

FIG. 9 is another perspective view of the preferred embodiment of the apparatus of the present invention;

FIG. 10 is a fragmentary side view of an alternate embodiment of the apparatus of the present invention;

FIG. 11 is a top view taken along lines 11-11 of FIG. 10;

FIG. 12 is a partial perspective view of the alternate embodiment of the apparatus of the present invention;

FIG. 13 is an elevation view of the preferred embodiment of the apparatus of the present invention showing connectable vertical channel sections;

FIG. 14 is a fragmentary view of the preferred embodiment of the apparatus of the present invention;

FIG. 15 is a fragmentary view of the preferred embodiment of the apparatus of the present invention;

FIG. 16 is a partial sectional view of the preferred embodiment of the apparatus of the present invention;

FIG. 17 is a side view of an alternate construction of the locking member;

FIG. 18 is a top view of the locking member of FIG. 17;

FIG. 19 is a perspective view of the locking member of FIG. 17;

FIG. 20 is side view of an alternate construction for the rail portion of the preferred embodiment of the apparatus of the present invention;

FIG. 21 is a fragmentary side view of the embodiment of FIGS. 17 and 20 of the apparatus of the present invention;

FIG. 22 is a similar view;

FIG. 23 is a fragmentary side view of the embodiment of FIG. 20 of the apparatus of the present invention;

FIG. 24 is an elevation view of another alternate embodiment of the apparatus of the present invention;

FIG. 25 is a top view of the embodiment of FIG. 24;

FIG. 26 is a sectional view taken along lines 26-26 of FIG. 24;

FIG. 27 is a fragmentary view of the embodiment of FIG. 24;

FIG. 28 is a fragmentary view taken along circle 28 of the embodiment of FIG. 24;

FIG. 29 is a fragmentary view taken along circle 29 of the embodiment of FIG. 24;

FIG. 30 is a fragmentary view of the embodiment of FIG. 24 and showing an alternate rail arrangement.

### DETAILED DESCRIPTION OF THE INVENTION

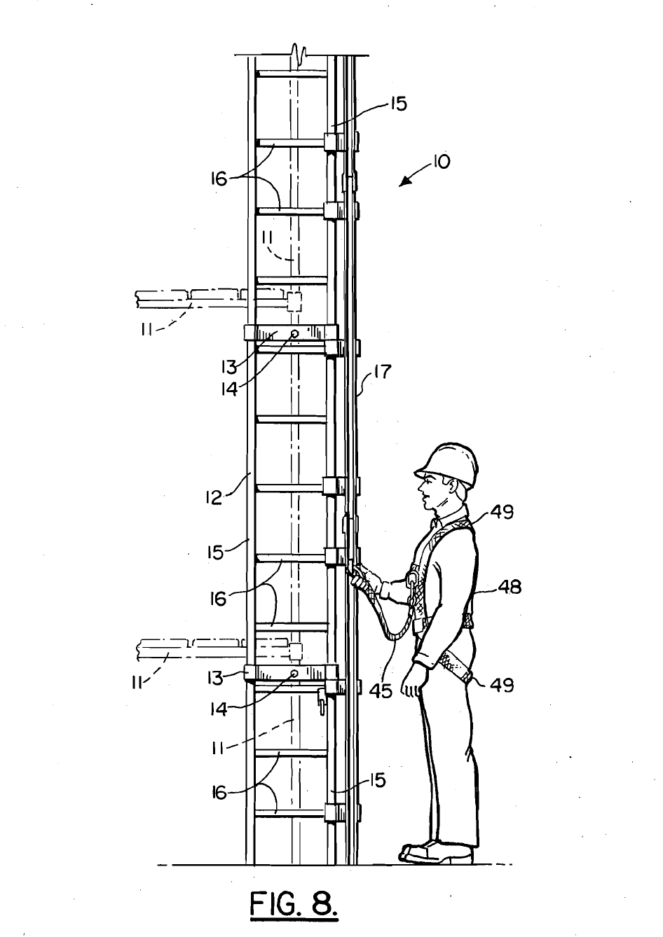

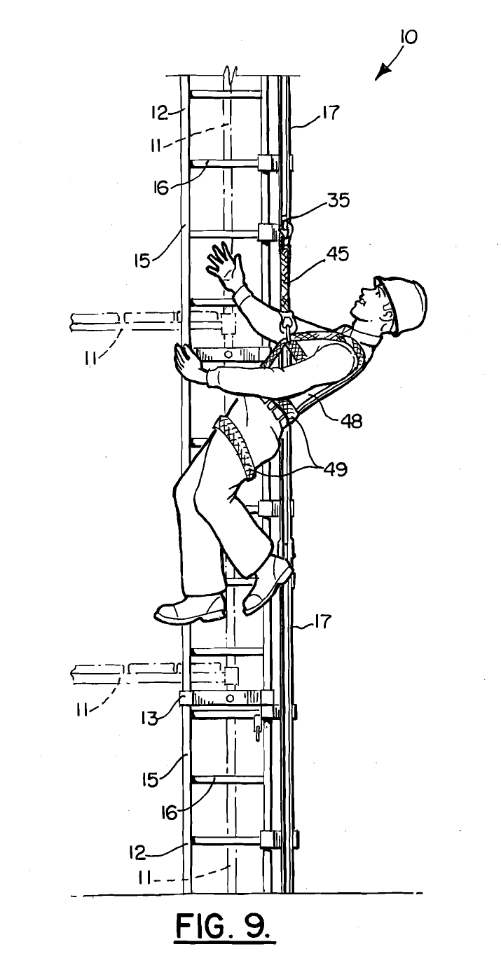

Ladder safety apparatus 10 is shown in FIGS. 8 and 9 in use at a construction site having scaffolding 11 to which is attached an elongated vertically extended ladder 12. The ladder 12 attaches to the scaffolding 11 using a plurality of brackets 13 and a bolted connection 14, for example. Ladder 12 includes rails 15 and rungs 16.

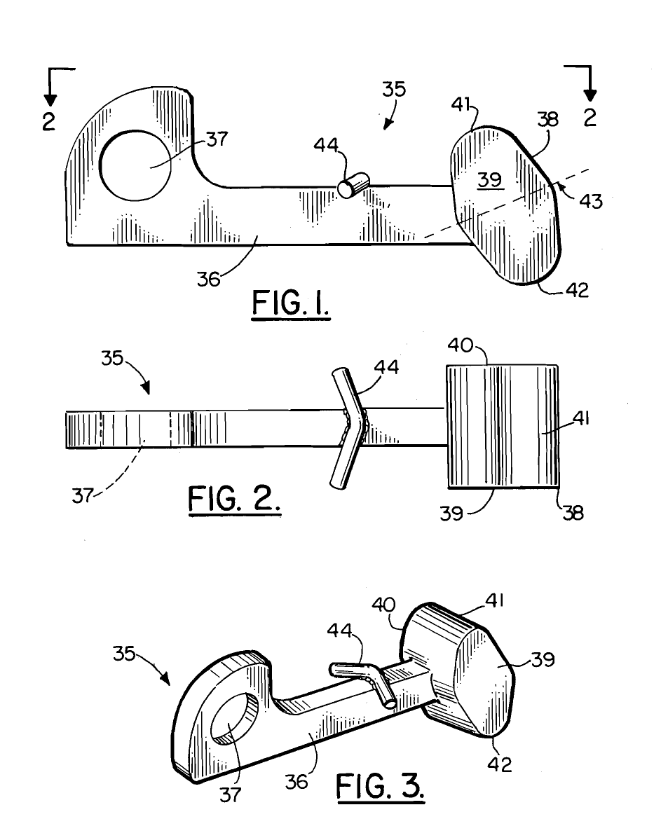

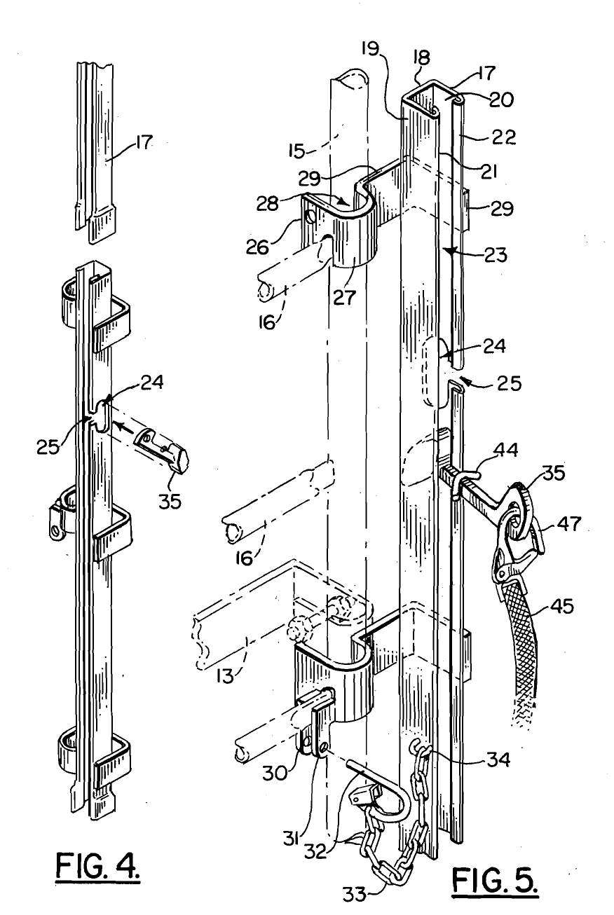

In FIGS. 4-9, an elongated vertical channel 17 is attached to ladder 12. The vertical channel 17 can include web 18 and flange 19, 20 sections. Each of the flanges 19, 20 has a folded portion for producing a narrowed gap 23. The flange 19 has folded portion 21. The flange 20 has folded portion 22 as shown in FIG. 5. The gap 23 is sized to be smaller than the width of the cam section 38 of locking member 35 measured between flat sides 39, 40 (see FIG. 2). In order to insert the locking member 35 into channel 17, an oval shaped opening 24 and slot 25 are provided as shown in FIGS. 4-5.

Channel 17 is connected to ladder 12 using fittings 26. Each fitting 26 can include a u-shaped section 27 providing recess 28 and an ell shaped portion 29. The ell shaped portion 29 and u-shaped section 27 can be integrally joined, being formed from a single piece of metal, flat bar or the like. One or more of the fittings 26 can be provided with perforated plates 30, 31 that are receptive of a locking pin 32 as shown in FIG. 5. The locking pin 32 can be retained with a chain 33 and attachment 34 as shown.

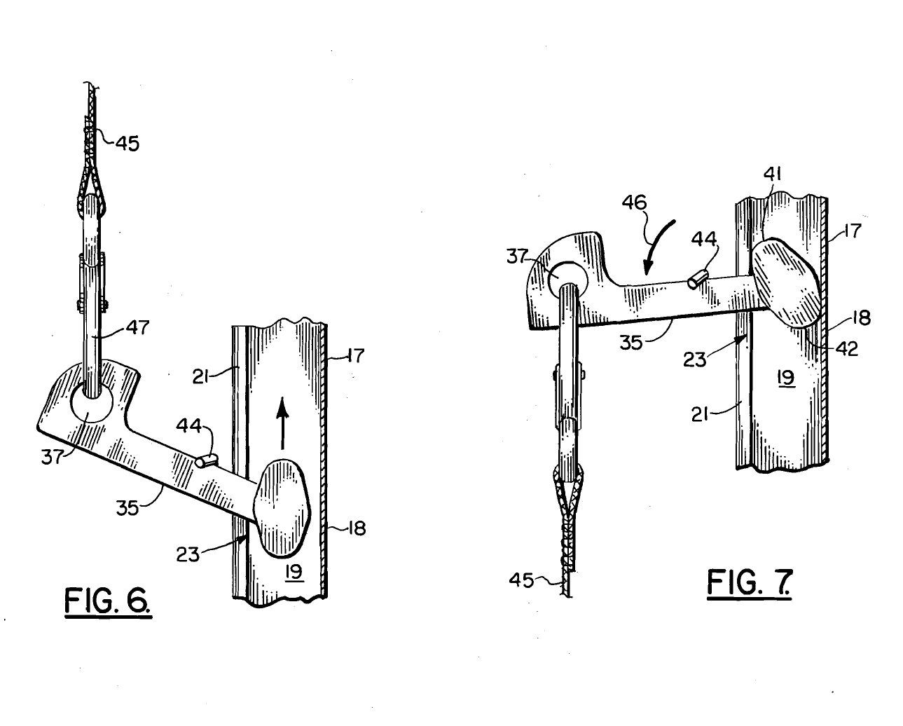

The locking member 35 (FIGS. 1-3) provides an elongated beam 36 having an eyelet 37 at one end portion and cam section 39 at the other end portion. The cam section 38 has two u-shaped surfaces 41, 42 that are joined at reference line 43. A stop 44 on beam 36 prevents excess movement of the locking member 35 when a user pulls it upwardly such as when climbing the ladder 12 (see FIG. 6).

In order to prevent injury to a user or climber 48 (see FIGS. 4-9), a strap, rope, or cable 45 can be used with a hook 47 to form an attachment between locking member 35 and a climber 48. The climber 48 can be equipped with a harness 49, or vest or belt or other suitable device that attaches to cable 45 so that if a climber 48 falls, the locking action of the locking member 35 with the vertical channel 17 provides an anchor that will support the weight of the climber 48 as shown schematically in FIG. 9. In FIG. 7, locking member 35 rotates in the direction of arrow 46 should the climber 48 lose his or her grip on ladder 12. In such a case (see FIG. 7), u-shaped surface 42 engages web 18 of channel 17 while u-shaped surface 41 engages folded portions 21, 22.

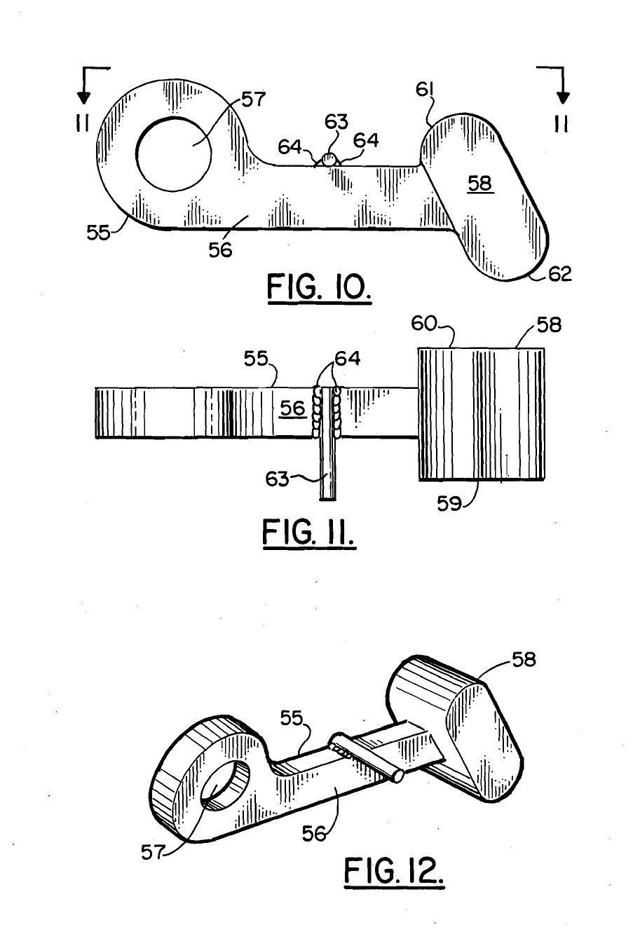

FIGS. 10-12 show an alternate configuration for a locking member, designated by the numeral 55. Locking member 55 provides a beam 56 having an eyelet 57 at one end portion and a cam section 58 at its other end portion as shown. The cam section 58 has opposed flat sides 59, 60. The cam section 58 has opposed surfaces that can be curved at 61, 62. Stop 63 is welded to beam 56 using weld 64. Otherwise, the locking member 55 can be interchanged with the locking member 35 of FIGS. 1-9.

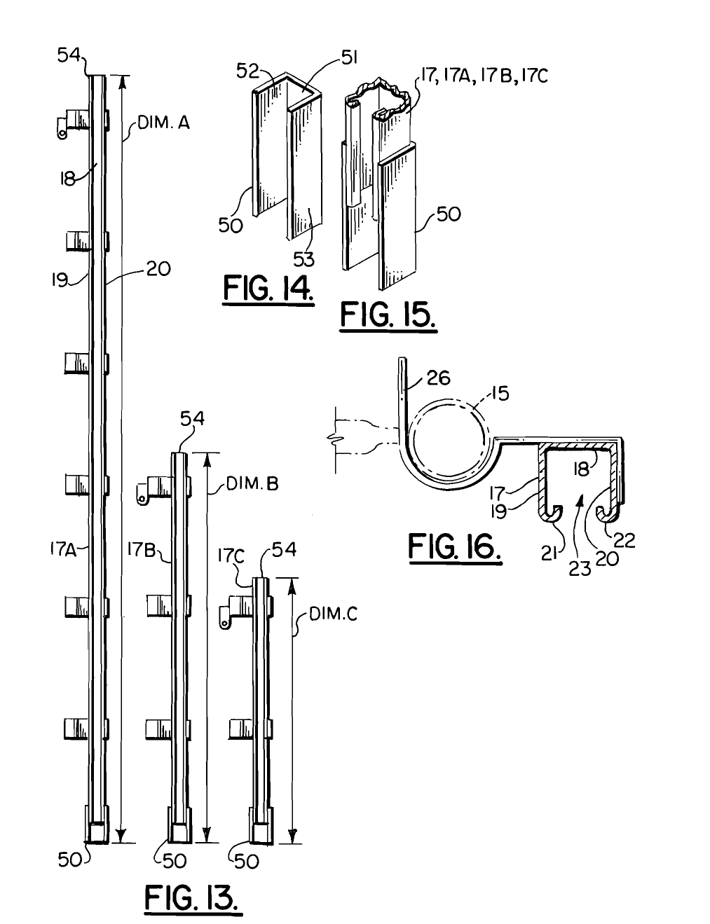

FIGS. 13-16 show an alternate configuration for vertical channel 17, mainly connectable sections 17A, 17B, 17C. The sections 17A, 17B, 17C can be provided in differing lengths as shown in FIG. 13, referencing the dimension lines A, B and C. Each of the sections 17A, 17B, 17C provides at its lower end portion a coupler 50. The coupler 50 can provide a web 51 and opposed flanges 52, 53 as shown in FIGS. 13-15. The coupler 50 can be connected (for example, welded) to the lower end portion of any of the selected channels 17, 17A, 17B, 17C. A portion (for example, about one half) of the coupler 50 is welded to the selected channel 17, 17A, 17B, 17C leaving about one half extending below the selected channel, as shown in FIG. 15. In such a fashion, the upper end portion 54 of the selected channels 17, 17A-17C can be fitted to the area under any one of the selected channels 17A, 17B, 17C of FIG. 13 to complete a splice. Thus, the upper end portion 54 of a channel section 17A-17C is fitted into the bottom of the coupler 50 that is attached to the lower end portion of a selected channel section 17A, 17B, 17C.

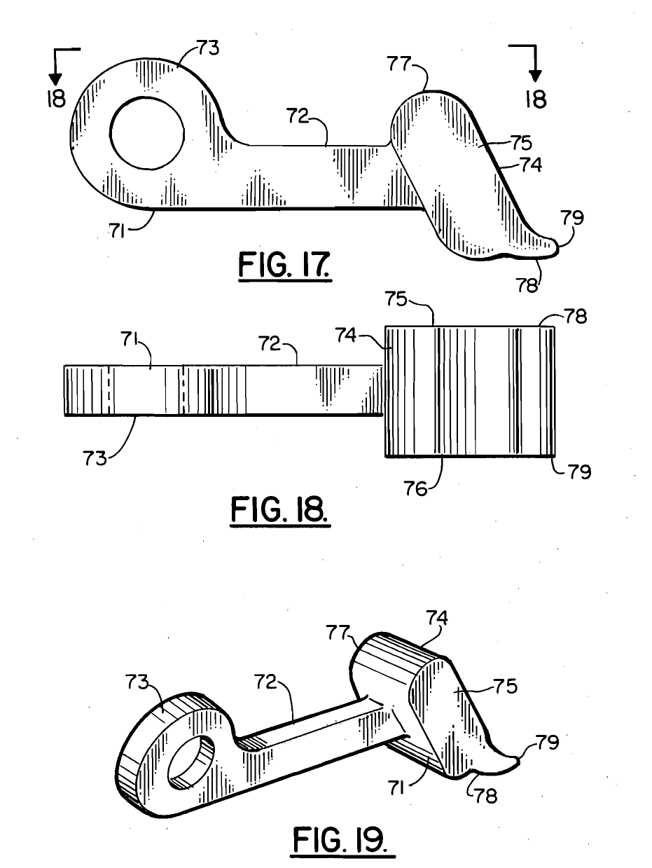

FIGS. 17-23 show an alternate construction for the rail 65 and locking member 71. The channel 65 has web 66 and flanges 67, 68 that provide an overall generally c-shaped transverse cross section. As with the channel 17 of FIGS. 4-9, folded portions 84, 85 can be provided on flanges 66, 67. A locking member opening 69 in channel 65 is an oblong opening 69 that enables locking member 71 (FIG. 19) to be added to the space or gap 70 that is in between the flanges 67, 68. The oblong opening 69 is sized and shaped to receive the cam section 74 of locking member 71 including its tail or locking tab 79. The tail or locking tab 79 is not found on the locking member 35 of the preferred embodiments of FIGS. 1-16.

Locking member 71 provides a beam 72 and eyelet 73. The eyelet 73 is (as with the preferred embodiment) a location for the attachment of a safety cable 45 and hook 47 thereto.

The improvements to the channel 65 and locking member 71 shown in FIGS. 17-23 work in the same manner as was shown and described with respect to FIGS. 1-16. The improvement of FIGS. 17-23 provide locking tail or locking tab 79 and its engagement with the wedge 80 that is attached (for example, welded at opening 81) to web 66 of rail 65.

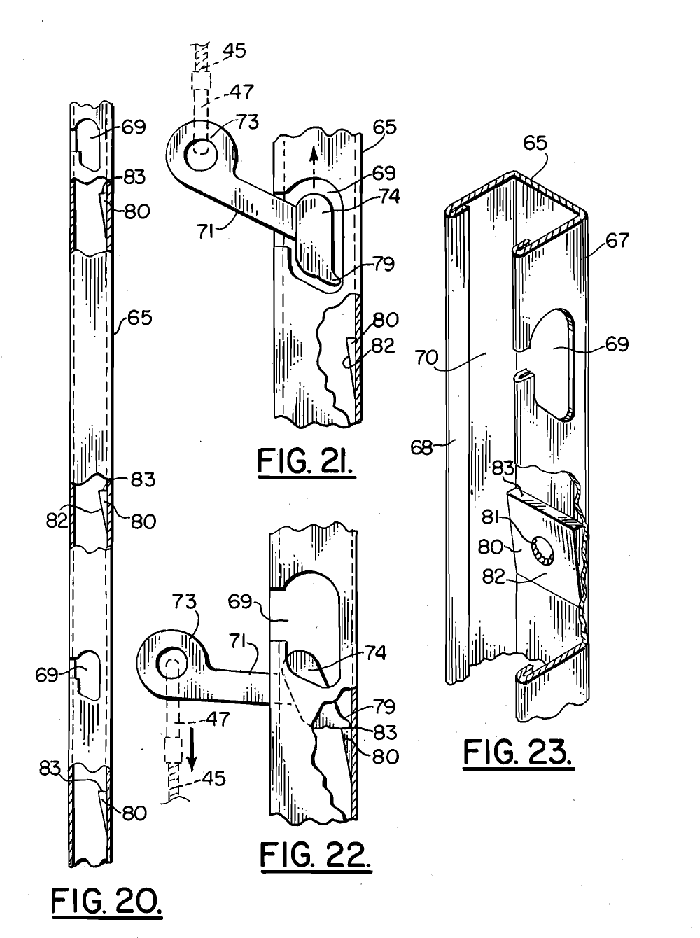

As with the preferred embodiment of FIGS. 1-16, the locking member 71 provides a cam section 74 having sides 75, 76 and u-shaped surface 77. Locking surface 78 provides a tail or locking tab 79 as shown in FIGS. 17-19. This tail or locking tab 79 engages wedge 80 as shown in FIG. 22 should a climber 48 inadvertently fall.

The wedge 80 has inclined surface 82 and transverse surface 83. If the climber 48 falls, as in FIGS. 5-9 and related text herein, the cable 45 attached to eyelet 73 will pull down on the eyelet 73, creating a moment in beam 72 so that it rotates (see arrow 46, FIG. 7) locking tab or tail 79 engages web 66 at surface 83. As the climber 48 falls downwardly, the locking member 71 will travel a short distance until locking tail or locking tab 79 stops upon wedge 80 transverse surface 83. The wedges 80 can be spaced apart for example, between about 12 and 24 inches (30 and 61 cm), and preferably about 18″ (46 cm) apart. The locking member openings 69 can be spaced between about 24 and 36 inches (61 and 91 cm) apart, and preferably about 32″ (81 cm) apart. The wedges 80 can, for example, be about ⅛″-1 inch (0.32-2.5 cm) wide, ⅛″-2″ (0.32-5.1 cm) high and 1/16″-⅛″ (0.16-0.32 cm) thick at their upper edges. The width of space 70 can be around 1″ (2.5 cm) for example.

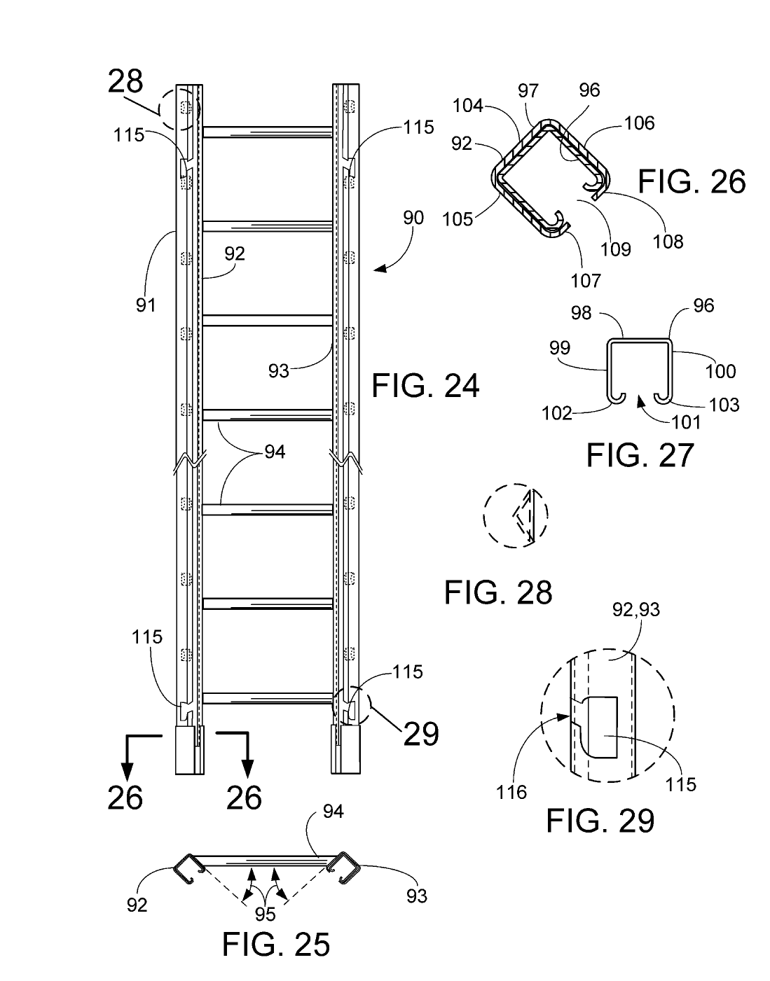

FIGS. 24-30 show an additional alternate embodiment of the apparatus of the present invention designated generally by the numeral 90. Ladder safety apparatus 90 provides a ladder 91 having spaced apart rails 92, 93. The rails 92, 93 are connected by rungs 94. Each of the rails 92, 93 have side flanges that form an acute angle 95 with the rungs 94. In FIGS. 26 and 27, each rail 92, 93 can be similarly constructed. Each rail 92, 93 is comprised of an inner section 96 and an outer section 97. The inner section 96 is shown in FIG. 27. Inner section 96 includes side flanges 99, 100 that form an acute angle with each rung 94. Inner section 96 also includes web 98. Each flange 99, 100 provides curved end portions 102, 103 as shown in FIG. 27. A gap or opening 101 is provided in between the curved end portions 102, 103.

The outer section 97 is shown in FIG. 26. Outer section 97 has a web 104 and side flanges 105, 106 attached thereto. Flanges 107, 108 are short flanges. Flange 107 is attached to flange 105, forming an angle of about 90 degrees with flange 105. Similarly, flange 108 forms an angle of about 90 degrees with side flange 106. A gap or opening 109 is provided in between the short flanges 107, 108 as shown in FIG. 26. FIGS. 28 and 29 are fragmentary views of the ladder safety apparatus in FIG. 24. FIG. 29 shows slot 116 and opening 115 in rail 92, 93.

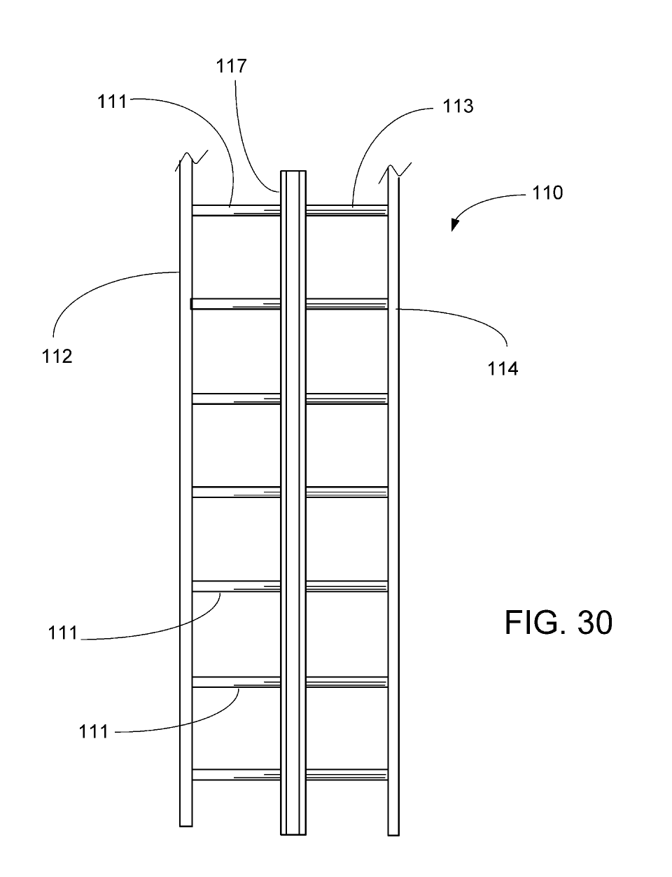

FIG. 30 shows an alternate arrangement of a ladder safety apparatus, designated generally by the numeral 110. In FIG. 30, each rung 111 attaches to a rail 112. Each rung 113 attaches to a rail 114. A central rail 117 is placed in between the rails 112, 114 as shown. Rail 117 can be of the same construction as the rail 92 or 93 of FIGS. 24-29, having the same cross section as shown in FIGS. 26 and 27.

The following is a list of parts and materials suitable for use in the present invention.

### PARTS LIST

| Part Number | Description |
|---|---|
| 10 | ladder safety apparatus |
| 11 | scaffolding |
| 12 | ladder |
| 13 | bracket |
| 14 | bolted connection |
| 15 | rail |
| 16 | rung |
| 17 | vertical channel |
| 17A | vertical channel section |
| 17B | vertical channel section |
| 17C | vertical channel section |
| 18 | web |
| 19 | flange |
| 20 | flange |
| 21 | folded portion |
| 22 | folded portion |
| 23 | gap |
| 24 | oval shaped opening |
| 25 | slot |
| 26 | fitting |
| 27 | u-shaped section |
| 28 | recess |
| 29 | ell shaped section |
| 30 | perforated plate |
| 31 | perforated plate |
| 32 | pin |
| 33 | chain |
| 34 | attachment |
| 35 | locking member |
| 36 | beam |
| 37 | eyelet |
| 38 | cam section |
| 39 | flat side |
| 40 | flat side |
| 41 | u-shaped surface |
| 42 | u-shaped surface |
| 43 | reference line |
| 44 | stop |
| 45 | cable |
| 46 | arrow |
| 47 | hook |
| 48 | climber |
| 49 | vest |
| 50 | coupler |
| 51 | web |
| 52 | flange |
| 53 | flange |
| 54 | upper end portion |
| 55 | locking member |
| 56 | beam |
| 57 | eyelet |
| 58 | cam section |
| 59 | flat side |
| 60 | flat side |
| 61 | u-shaped surface |
| 62 | u-shaped surface |
| 63 | stop |
| 64 | weld |
| 65 | channel |
| 66 | web |
| 67 | flange |
| 68 | flange |
| 69 | oblong opening |
| 70 | slot/gap |
| 71 | locking member |
| 72 | beam |
| 73 | eyelet |
| 74 | cam section |
| 75 | flat side |
| 76 | flat side |
| 77 | u-shaped surface |
| 78 | locking surface |
| 79 | tail/locking tab |
| 80 | wedge |
| 81 | opening |
| 82 | inclined surface |
| 83 | transverse surface |
| 84 | folded portion |
| 85 | folded portion |
| 90 | ladder safety apparatus |
| 91 | ladder |
| 92 | rail |
| 93 | rail |
| 94 | rung |
| 95 | angle |
| 96 | inner section |
| 97 | outer section |
| 98 | web |
| 99 | flange |
| 100 | flange |
| 101 | gap/opening |
| 102 | curved end portion |
| 103 | curved end portion |
| 104 | web |
| 105 | flange |
| 106 | flange |
| 107 | flange |
| 108 | flange |
| 109 | gap/opening |
| 110 | ladder safety apparatus |
| 111 | rung |
| 112 | rail |
| 113 | rung |
| 114 | rail |
| 115 | opening |
| 116 | slot |
| 117 | central rail |

All measurements disclosed herein are at standard temperature and pressure, at sea level on Earth, unless indicated otherwise.

The foregoing embodiments are presented by way of example only; the scope of the present invention is to be limited only by the following claims.

1. A safety ladder that protects a climber from a fall, comprising:
a) a supported ladder having a pair of rails and a plurality of rungs connecting the rails;
b) at least one rail comprising an elongated channel having multiple flanges surrounding a passageway, at least two of the flanges being side flanges that are generally parallel, a pair of the flanges being shorter flanges defining there between a gap, wherein the rungs form an acute angle of less than 75 degrees with one of the flanges;
c) a locking member having a beam, a cam section at one end portion of the beam that is configured to travel in the passageway and a connector section positioned on the beam opposite the cam section and outside of the passageway;
d) a cable tied to the connector section that enables a connecting of a climber to the connector section; and
e) the cam section being configured to form an anchor with two opposed of the flanges of the channel in a locking position when all or part of a climber's weight transfers to the cable forcing the locking member to move downwardly.

2. The safety ladder of claim 1 wherein the cable connector section is an eyelet.

3. The safety ladder of claim 1 wherein the beam and cam section are a one piece structure.

4. The safety ladder of claim 1 wherein the cam section has a pair of opposed U-shaped surfaces.

5. The safety ladder of claim 1 wherein the cam bears against opposing surfaces of the channel.

6. The safety ladder of claim 1 wherein the channel includes a web, a pair of flanges connected to the web, and each of the flanges having a fold next to the gap.

7. The safety ladder of claim 1 wherein the locking member can be lifted relative to the channel by lifting on the cable.

8. The safety ladder of claim 1 wherein the cam section has a maximum length between the U-shaped surfaces that is greater than the maximum transverse thickness of the rail.

9. The safety ladder of claim 6 wherein the cam section engages the web and the flanges having the folds when in the locking position.

10. The safety ladder of claim 1 wherein the channel has an opening in one of the flanges that enables the locking member to be removed from or added to the channel via the opening.

11. The safety ladder of claim 1 further comprising stops mounted at intervals on the channel.

12. The safety ladder of claim 11 wherein each stop is wedge shaped.

13. The safety ladder of claim 11 wherein the stops are positioned about 1 to 2 feet (30 to 61 cm) apart.

14. The safety ladder of claim 11 wherein the locking member has a cam section with a tail that extends away from the cam section.

15. The safety ladder of claim 6 further comprising stops mounted at intervals on the channel, wherein each stop is wedge shaped.

16. The safety ladder of claim 15 wherein each stop is generally wedge shaped.

17. The safety ladder of claim 16 wherein each stop is connected to the web of the channel.

18. The safety ladder of claim 1 wherein one of the flanges has a locking member opening that enables the cam section of the locking member to be placed through the opening an into the gap.

19. The safety ladder of claim 18 wherein there are multiple spaced apart locking member openings.

20. The safety ladder of claim 19 wherein the locking member openings are spaced about 2-3 feet (61-91 cm) apart.

21. The safety ladder of claim 1 wherein the angle is about forty five degrees.

22. The safety ladder of claim 1 wherein the rungs form an angle of less than 75 degrees with one of the side flanges.

23. (canceled)
